(19) United States
(12) Patent Application Publication
(10) Pub. No.: US 2008/0302886 A1
(43) Pub. Date: Dec. 11, 2008

(54) Shower Head

(75) Inventors: Benjamin Hodel, Jona (CH); Lutz Alteneder, Rapperswil (CH); Henning Kaess, Rapperswil (CH)

Correspondence Address: SUGHRUE MION, PLLC, 2100 PENNSYLVANIA AVENUE, N.W., SUITE 800, WASHINGTON, DC, 20037, US

(73) Assignee: WEIDMANN PLASTICS TECHNOLOGY AG, Rapperswil (CH)

(21) Appl. No.: 11/908,317

(22) PCT Filed: Mar. 9, 2006
(86) PCT No.: PCT/CH2006/000143

§ 371 Date: Sep. 11, 2007

(30) Foreign Application Priority Data
Mar. 11, 2005 (CH) 428/05

(51) Int. Cl. B05B 1/14; B05B 1/18

(52) U.S. Cl. 239/443

(57) ABSTRACT

The invention relates to a shower head which comprises a housing (2) wherein a valve (V), which comprises a closing body (10) which can be adjusted between two closing positions by changing the type of jet by means of an actuation device (19), is arranged. The actuation device (19) comprises a rotating wheel (33, 41, 51, 61, 71) which is arranged on the outer side of the housing (2), said rotating wheel being actively connected to the closing body (10) such that it can manually rotate in a limited manner in order to adjust the closing body (10). A valve pipe (3) is arranged in the housing (2), whereon the rotating wheel (33, 41, 51, 61, 71) is mounted in a rotationally limited manner. Said shower head can be manually actuated in a simple manner and can consist of very few parts.

The invention relates to a spray head having a housing which contains a valve which has a closure body which can be adjusted between two closure positions, in order to change over the type of jet, by an actuating device.

A spray head of this type has been disclosed, for example, in DE 198 03 554 A. This spray head is provided, in particular, for a pullout spray or dishwashing spray. The spray head is connected to a hose line which is guided in a displaceable manner in a curved tube. The spray head can be pulled out of the bottom of the curved tube. Such sprays are also referred to as pull-down sprays. The valve is a switchover valve which can be switched over by a lever, in which case optionally two different jet formations are possible. The lever here is hidden from view beneath an elastomeric membrane. Changeover takes place at two different, spaced-apart actuating locations of the membrane.

A pullout spray has likewise been disclosed in EP 1 418 007 A of the prior art. In this case, for actuation purposes, a lever is likewise arranged beneath an elastomeric membrane. This lever acts, via a tilting element (toggle wedge), on the closure body of the switchover valve in order to displace the latter between the two positions.

EP 1 462 051 A discloses a dishwashing spray which has, as actuating element, an externally arranged lever. In a pivoted-in position, this lever can be fixed on a retaining ring. For changeover purposes, this retaining ring has to be rotated. Actuation here is comparatively laborious.

EP 0 704 252 A discloses a spray having a handle which is likewise arranged beneath an elastomeric membrane.

GB 2 185 019 A discloses a spray which has a laterally projecting lever for actuating an outflow valve. This spray, however, cannot be changed over between two types of jet.

U.S. Pat. No. 6,378,790 B discloses a spray or shower which has a rotary lever for actuating purposes. This rotary lever projects on the outside of the housing.

The object of the invention is to provide a spray head of the type mentioned which can be actuated more easily and, in addition, can be produced cost-effectively from just a small number of parts.

The object is achieved, in the case of a spray head of the generic type, in that the actuating device has a rotary wheel which projects on the outside of the housing and, for the purpose of adjusting the closure body, can be rotated to a limited extent by hand and is operatively connected to the closure body. The rotary wheel allows very straightforward single-point actuation and single-handed actuation. There is no need to find any other position for the purpose of changing over the type of jet, which is critical in particular in the case of a pullout spray. Actuation for changing over the valve is effected, for example, by the thumb of the hand which is gripping the spray head. Since the rotary wheel projects externally, and is thus not concealed beneath a membrane, it is also readily clear on first use how and where actuation should take place. The spray head is particularly suitable for a pullout spray.

According to a development of the invention, it is provided that a valve tube is arranged in the housing, and that the rotary wheel is mounted in a rotatable manner externally on this valve tube. This development makes it possible to design the spray head such that a full functional check can be carried out even in the absence of a housing. The spray head can then also be supplied without a housing. The housing, in this case, is fitted, for example, by a dealer. He can keep a stock of different housings, for example housings with different surfaces, and can fit the housing appropriate to the customer's wishes.

According to a development of the invention, it is provided that the rotary wheel can be inserted into the housing through an opening therein. During assembly of the spray head, once the housing has been placed in position, the rotary wheel, finally, is inserted through the opening of the housing. Insertion of the rotary wheel is particularly straightforward and functionally reliable when it is latched on to a bearing part arranged in the housing. This bearing part is preferably a bearing block which is integrally formed on the abovementioned valve tube.

According to a development of the invention, it is provided that the rotary wheel is connected to the closure body by way of a connecting part. This connecting part can be connected straightforwardly to the rotary wheel in a form-fitting or frictionally fitting manner. The connection is particularly straightforward when, according to a development of the invention, the connecting part has, at one end, an opening in which an extension of the rotary wheel engages. Such a connection is comparatively insensitive to tolerances. Fitting, in addition, is likewise very straightforward and allows the abovementioned latching connection between the rotary wheel and a bearing block of the valve tube.

According to a development of the invention, it is provided that the connecting part is mounted in a displaceable manner on the abovementioned valve tube. For mounting purposes, bearing parts are integrally formed, for example, on the outside of the valve tube, it being possible for the connecting part to be pushed laterally into these bearing parts. The connecting part is preferably located in an interspace between the abovementioned valve tube and the housing. This allows the spray head to be of very narrow design. In particular, this spray head, in a manner similar to a flashlight, may be of circular-cylindrical design.

According to a development of the invention, it is provided that the rotary wheel has, as a driver, a pin which projects essentially radially away from the axis of rotation of the rotary wheel. This pin is operatively connected preferably in a form-fitting manner to the closure body. This allows a very straightforward and functionally reliable construction.

According to a development of the invention, it is provided that the rotary wheel is operatively connected in a frictionally fitting manner to the closure body. The rotary wheel preferably has a frictional surface, which butts against a corresponding frictional surface of the closure body. This frictional surface is preferably arranged on a connecting part and is planar.

According to a development of the invention, it is provided that the rotary wheel is connected to the closure body by way of an articulation part. This allows the rotary wheel to be formed integrally with the connecting part. The rotary wheel may be produced in one piece with the connecting part, for example by injection molding. This allows an even more straightforward and cost-effective construction.

According to a development of the invention, it is provided that the articulation part has at least one film hinge, preferably two spaced-apart film hinges. The articulation part preferably has, at one end, a two-armed lever which acts on the closure body by way of one arm in order to displace this closure body. This allows a particularly straightforward construction having just a small number of individual parts.

According to a development of the invention, it is provided that the rotary wheel is operatively connected to the closure body via a toothing connection. This allows a particularly functionally reliable connection between the rotary wheel and the closure body.

Further advantageous features can be gathered from the dependent patent claims, from the following description and from the drawing.

Exemplary embodiments of the invention will be explained in more detail hereinbelow with reference to the drawing, in which:

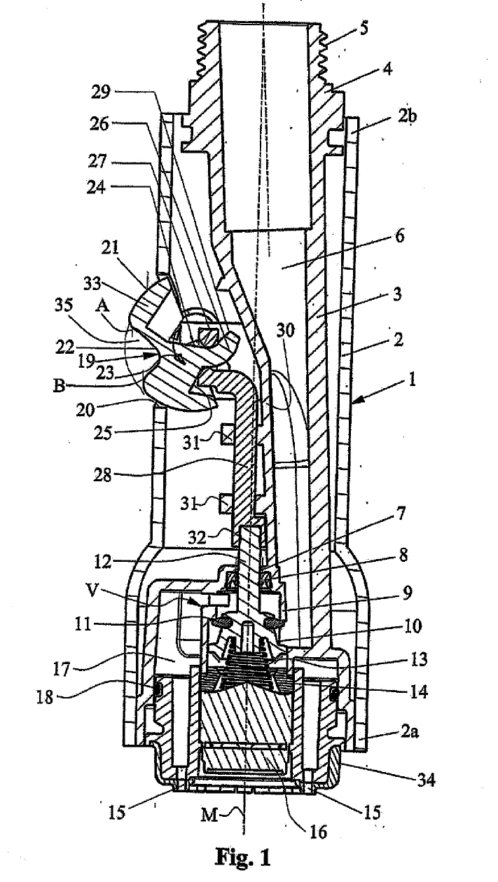

FIG. 1 shows, on an enlarged scale, a longitudinal section through a spray head according to the invention,

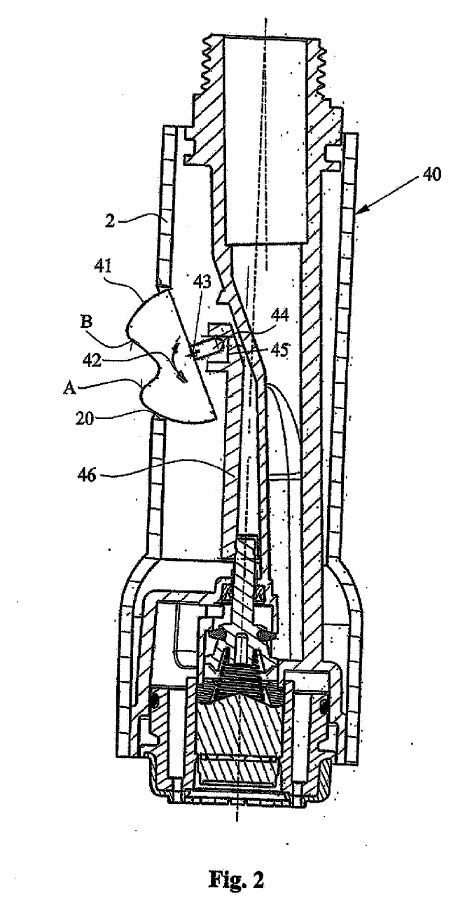

FIG. 2 shows a longitudinal section through one variant of a spray head,

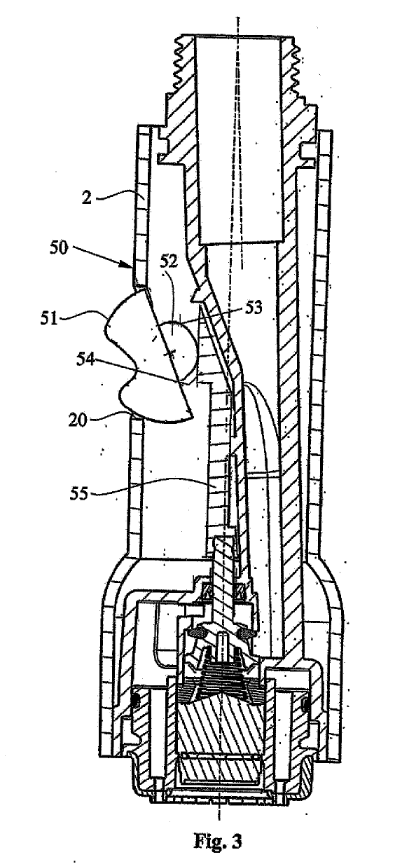

FIG. 3 shows a longitudinal section through a further variant of a spray head,

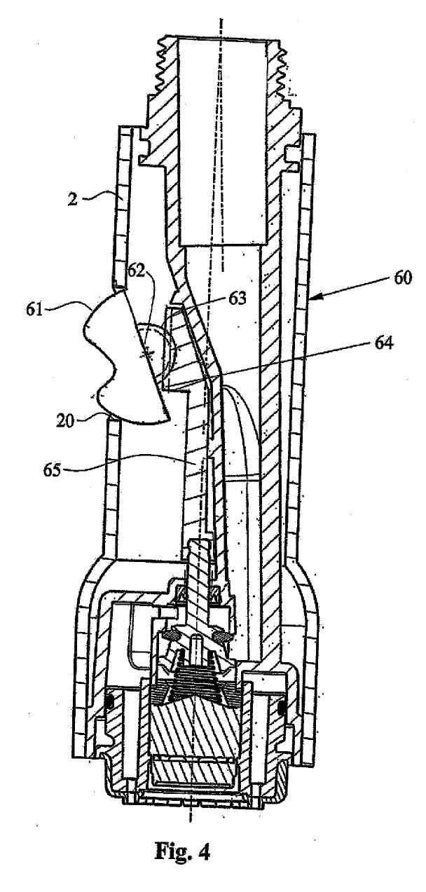

FIG. 4 shows a longitudinal section through a further variant of a spray head,

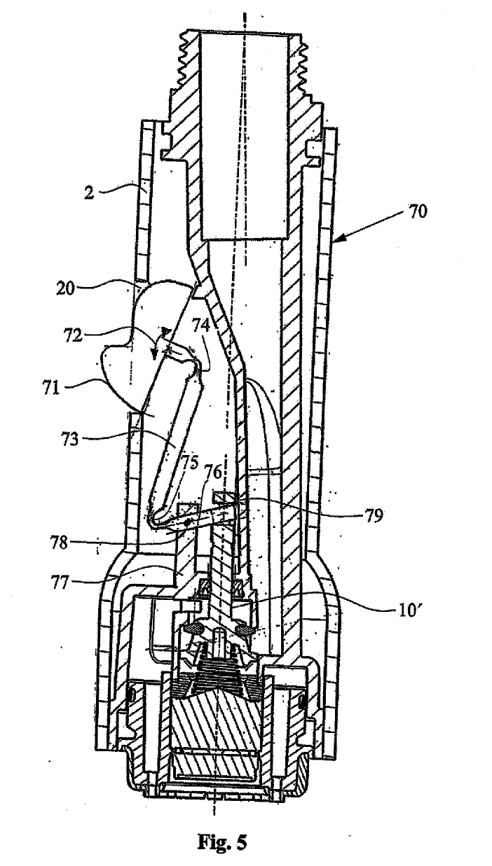

FIG. 5 shows a longitudinal section through a further variant of a spray head,

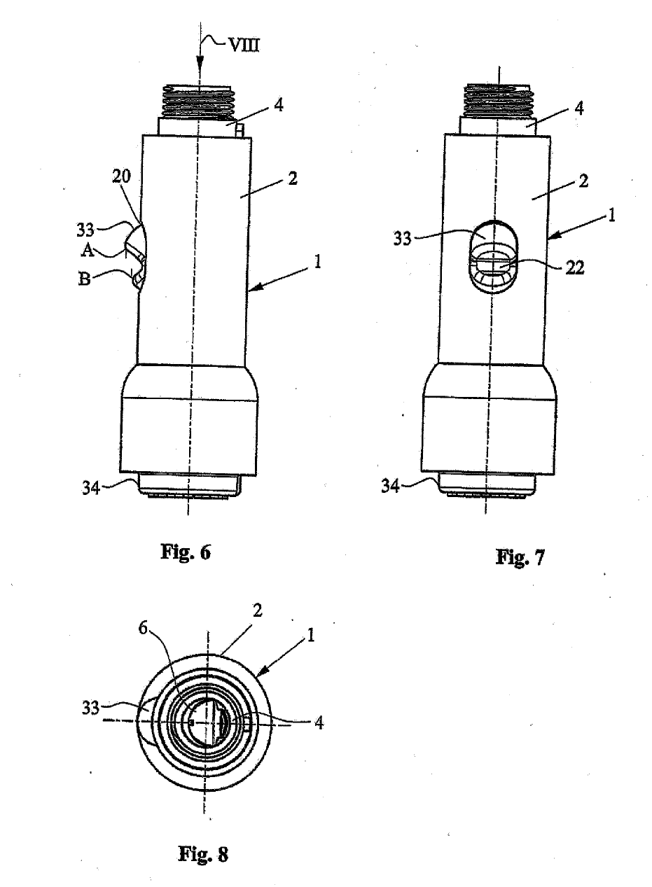

FIG. 6 shows a side view of a spray head according to the invention,

FIG. 7 shows a further view of the spray head according to the invention, and

FIG. 8 shows a view in the direction of arrow VIII in FIG. 6.

The spray head 1 which is shown in FIG. 1 has an essentially circular-cylindrical housing 2 in which a water-channeling tube 3 is mounted. At an edge which projects out of the housing 2, the water-channeling tube 3 has a connection stub 4 with a connection thread 5, at which the spray head 1 is connected to a hose (not shown here). This hose is preferably mounted for pullout action in a curved tube (not shown here). The spray head 1 can then be pulled out, for example, downward and can be used, in particular, as a dishwashing spray.

Arranged at the other end of the water-channeling tube 3 is an insert 34 which is known per se, is sealed by a sealing ring 18 in relation to the water-channeling tube 3 and has outlet openings 15 for a spray jet and, in the center, a jet former 16. The water jet is formed either by the outlet openings 15 or by the jet former 16. Two types of jet are thus possible here. Suitable inserts 34 are known to the person skilled in the art and therefore need not be explained in any more detail here.

Passing through the water-channeling tube 3 is a water channel 6, through which water can pass from the connection stub 4 to the insert 34. The water is controlled by a valve V, which is a changeover valve and has a closure body 10 on which a connecting rod 12 is integrally formed, the connecting rod projecting through a through-passage 7 of the water-channeling tube 3. The connecting rod 12 is sealed in relation to the water-channeling tube 3 by a sealing body 8. The closure body 10 can be displaced to a limited extent in the longitudinal direction of the connecting rod 12. If, in FIG. 1, the closure body 10 has moved downward, then a spring 13 is subjected to stressing. In the position shown, a sealing body 11 butts against a valve seat 9. If the closure body 10 is moved downward counter to the reactive force of the spring 13, then the water channel 6 is connected to a chamber 17 and the outlet openings 15. If the closure body 10 is located in the bottom position, then it butts against an elastomeric sealing body 14 and thus closes the connection between the water channel 6 and the jet former 16. If a faucet (not shown here) is shut off, and the pressure in the water channel 6 is thus reduced, then the stressed spring 13 moves the closure body 10 into the position shown in FIG. 1. In the basic state, the closure body 10 is thus always located in the position shown in FIG. 1, in which the water channel 6 is connected to the jet former 16.

In order to displace the closure body 10 between the two positions mentioned, an actuating device 19 is provided, this device having a rotary wheel 33 and a connecting part 28. The rotary wheel 33 can be rotated to a limited extent about an axis of rotation 24 and projects through an aperture 20. The rotary movements of the rotary wheel about the axis 24 are illustrated by the double arrow 23. For mounting a rotary wheel 33, a bearing block 29 is integrally formed on a wall 30 of the water-channeling tube 33. This bearing block 29 has openings (not shown here) into which bearing pins (not shown here) of the rotary wheel 33 are latched. The latching connection between the rotary wheel 33 and the bearing block 29 is designed such that the rotary wheel 33 can be latched on to the bearing block 29 through the opening 20.

In order that the rotary wheel 33 can be rotated in a rocker-like manner about the axis of rotation 24 in the directions of the double arrow 23, it has, on the outer surface 21, a depression 22, which forms two opposite contact surfaces A and B. If, for example, the thumb applies pressure to the contact surface A, then the rotary wheel 33 pivots in the clockwise direction about the axis of rotation 24 and the closure body 10 in FIG. 1 is thus moved downward. The sealing body 11 therefore lifts off from the valve seat 9 and water can thus pass out through the outlet openings 15. If pressure is subsequently applied to the contact surface B, then the rotary wheel 33 pivots back into the position which is shown in FIG. 1. For the two pivoting movements, the thumb need not be lifted off from the rotary wheel 33. So-called single-point actuation is thus possible.

The rotary wheel 33 has a stub-like curved extension 26 which engages in a through-passage 27 of the connecting part 28. The extension 26 forms a driver by means of which the pivoting movement of the rotary wheel 33 is converted into a linear movement of the connecting part 28. On the circumference of the extension 26, the rotary wheel 33 has a recess 25 on the rear side.

The connecting part 28 is a rod which, in FIG. 1, is fixed to the connecting rod 12 at the bottom end by means of a connection 32. The connection 32 may be a clamping connection, latching connection, an adhesive bond or the like. For mounting the connecting part 28, two bearing parts 31 are integrally formed on the wall 30, and the connecting part 28 is inserted laterally on to these bearing parts. The connecting part 28 extends essentially in the longitudinal direction of the connecting rod 12, and thus in the direction of the center line M of the spray head 1. As can be seen, the axis of rotation 24 of the rotary wheel 33 is located at a distance from the point where the rotary wheel meets the through-passage 27. This distance is preferably smaller than the distance between the axis of rotation 24 and the outer surface 21 of the rotary wheel. The power arm of the rotary wheel 33 is thus preferably greater than the work arm, which allows a comparatively large pivoting angle and a comparatively small actuating force. This angle is preferably greater than approximately 45°.

Instead of the depression 22, it is also possible to provide a molded-on part 35, which is indicated by a dashed line. This molded-on part 35 consists, for example, of a plastic which has a surface with a comparatively large coefficient of friction. An example of a suitable plastic is an elastomeric plastic. Actuation thus takes place by way of the molded-on part 35, on which, for example, the thumb is placed.

FIG. 2 shows a spray head 40 which is of basically the same construction as the spray head 1. The actuating device here, however, has a rotary wheel 41, which likewise has two contact surfaces A and B or a molded-on part 35 and is mounted such that it can be pivoted about an axis of rotation 43. The pivoting movement here is indicated by the double arrow 42. A rod-like driver 44 is integrally formed on the rotary wheel 41, and engages in a depression 45 of a connecting part 46. When the rotary wheel 41 is pivoted about the axis 43, the driver 44 is pivoted correspondingly and the connecting part 46 in FIG. 2 is thus displaced downward or upward. Accordingly, the closure body 10 is displaced from one position into the other.

FIG. 3 shows a spray head 50, which has a rotary wheel 51 with a driver 52 which is of semicircular design and has a correspondingly curved frictional surface 53. This frictional surface 53 butts against a frictional surface 54 of a connecting part 55. When the rotary wheel 51 is rotated, the frictional surface 53 rolls on the frictional surface 54 and displaces the connecting part 55 correspondingly. The driver 52 may be, for example, a molded-on part made of an elastomeric material.

FIG. 4 shows a spray head 60, which has a rotary wheel 61 with a driver 62 which has a toothing formation 63 on its circumference. This toothing formation 63 meshes with a toothing formation 64 of a connecting part 65. When the rotary wheel 61 is rotated, the toothing formation 63 rolls on the toothing formation 64 and the connecting part 65, and thus the closure body 10, is displaced correspondingly.

FIG. 5 shows a spray head 70 which, for actuating the valve V, has a rotary wheel 71 which can be pivoted to a limited extent in the directions of the double arrow 72. Connection to the closure body 10′ takes place by way of a connecting part 73 which is integrally formed on the rotary wheel 71 and has two spaced-apart hinges 74 and 75. These two hinges are preferably film hinges. One end of the connecting part 73 forms a two-armed lever 76, which is mounted on a bearing part 77. The lever 76 can be pivoted about an axis 78 and engages, by way of its free end, in a recess 79 of the closure body 10′. The pivoting movements on the rotary wheel 71 are transmitted, via the connecting part 73, to the closure body 10′, and these are correspondingly displaced downward or upward in FIG. 5. The rotary wheel 71 may be produced in one piece with the connecting part 73 by injection molding. This further reduces the number of individual parts.

FIGS. 6 to 8 show the outside for example of the spray head according to FIG. 1. However, the illustrations also apply to the spray heads according to FIGS. 2 to 5. The only differences therefore are constituted by the parts arranged in the interior of the housing 2. As can be seen, the rotary wheel 33 projects beyond the outside of the housing 2. If the spray head 1 is gripped in the hand, then the rotary wheel 33 can be rotated or tilted by the thumb. The thumb here is positioned, in particular, in the depression 22. If the molded-on part 35 shown in FIG. 1 is provided, then the thumb is placed correspondingly on this molded-on part 35. As can be seen, the spray head 1 is of essentially circular-cylindrical design.

### LIST OF DESIGNATIONS

1 Spray head
2 Housing
2a Front end
2b Rear end
3 Water-channeling tube
4 Connection stub
5 Connection thread
6 Water channel
7 Through-passage
8 Sealing body
9 Valve seat
10 Closure body
11 Sealing body
12 Connecting rod
13 Spring
14 Sealing body
15 Outlet openings
16 Jet former
17 Chamber
18 Sealing ring
19 Actuating device
20 Aperture
21 Outer surface
22 Depression
23 Double arrow
24 Axis of rotation
25 Recess
26 Extension
27 Through-passage
28 Connecting part
29 Bearing block
30 Wall
31 Bearing part
32 Connection
33 Rotary wheel
34 Insert
35 Molded-on part
40 Spray head
41 Rotary wheel
42 Double arrow
43 Axis of rotation
44 Driver
45 Depression
46 Connecting part
50 Spray head
51 Rotary wheel
52 Driver
53 Frictional surface
54 Frictional surface
55 Connecting part
60 Spray head
61 Rotary wheel
62 Driver
63 Toothing formation
64 Toothing formation
65 Connecting part
70 Spray head
71 Rotary wheel
72 Double arrow
73 Connecting part
74 First hinge
75 Second hinge
76 Lever
77 Bearing part
78 Axis of rotation
79 Recess
A Contact surface
B Contact surface
M Center line
V Valve

1. A spray head having a housing which contains a valve which has a closure body which can be adjusted between two closure positions, in order to change over the type of jet, by an actuating device, wherein the actuating device has a rotary wheel which projects on the outside of the housing and, for the purpose of adjusting the closure body, can be rotated to a limited extent by hand and is operatively connected to the closure body.

2. The spray head as claimed in claim 1, wherein a water-channeling tube is arranged in the housing , and in that the rotary wheel is mounted on this water-channeling tube such that it can be rotated to a limited extent.

3. The spray head as claimed in claim 1, wherein the rotary wheel is inserted into the housing through an opening therein.

4. The spray head as claimed in claim 1, wherein the rotary wheel is latched on to a bearing part arranged in the housing.

5. The spray head as claimed in claim 1, wherein the rotary wheel is connected to the closure body by way of a connecting part.

6. The spray head as claimed in claim 5, wherein the connecting part has, at one end, an opening in which an extension of the rotary wheel engages.

7. The spray head as claimed in claim 5, wherein the connecting part is mounted in a displaceable manner on a water-channeling tube.

8. The spray head as claimed in claim 5, wherein the connecting part is arranged in an interspace between the housing and a water-channeling tube.

9. The spray head as claimed in claim 1, wherein the rotary wheel has, as a driver, a pin which projects essentially radially away from the axis of rotation of the rotary wheel.

10. The spray head as claimed in claim 1, wherein the rotary wheel is operatively connected in a frictionally fitting manner to the closure body.

11. The spray head as claimed in claim 10, wherein the rotary wheel has, as driver, a circular frictional surface.

12. The spray head as claimed in claim 1, wherein the rotary wheel is connected to the closure body by way of an articulation part.

13. The spray head as claimed in claim 12, wherein the articulation part has at least one film hinge, preferably two film hinges.

14. The spray head as claimed in claim 12, wherein the articulation part is integrally formed at one end of the rotary wheel.

15. The spray head as claimed in claim 12, wherein the articulation part has, at one end, a two-armed lever which acts on the closure body by way of one arm.

16. The spray head as claimed in claim 1, wherein the rotary wheel is operatively connected to the closure body via a toothing connection.
